(19) United States
(12) Patent Application Publication
(10) Pub. No.: US 2022/0351501 A1
(43) Pub. Date: Nov. 3, 2022

(54) THREE-DIMENSIONAL TARGET DETECTION AND MODEL TRAINING METHOD AND DEVICE, AND STORAGE MEDIUM

(71) Applicant: SHANGHAI SENSETIME INTELLIGENT TECHNOLOGY CO., LTD., Shanghai (CN)

(72) Inventors: Le DONG, Shanghai (CN); Ning ZHANG, Shanghai (CN); Xianglei CHEN, Shanghai (CN); Lei ZHAO, Shanghai (CN); Ning HUANG, Shanghai (CN); Liang ZHAO, Shanghai (CN); Jing YUAN, Shanghai (CN)

(21) Appl. No.: 17/847,862

(22) Filed: Jun. 23, 2022

Related U.S. Application Data
(63) Continuation of application No. PCT/CN2020/103634, filed on Jul. 22, 2020.

(30) Foreign Application Priority Data
Dec. 27, 2019 (CN) 201911379639.4

(51) Int. Cl. G06V 10/776; G06V 20/64; G06T 7/70; G06V 10/22; G06T 7/60

(52) U.S. Cl. CPC G06V 10/776; G06V 20/64; G06T 7/70; G06V 10/22; G06T 7/60; G06V 2201/07; G06T 2207/20081; G06T 2207/20084

(57) ABSTRACT

A sample three-dimensional image is acquired. The sample three-dimensional image is labeled with actual location information of an actual region of a three-dimensional target. One or more pieces of prediction region information corresponding to one or more sub-images of the sample three-dimensional image are acquired by performing target detection on the sample three-dimensional image using the three-dimensional target detection model. Each piece of the prediction region information includes prediction confidence and prediction location information of a prediction region. A loss value of the three-dimensional target detection model is determined using the actual location information and the one or more pieces of the prediction region information. A parameter of the three-dimensional target detection model is adjusted using the loss value.

### CROSS-REFERENCE TO RELATED APPLICATION

This application is a continuation of International Patent Application No. PCT/CN2020/103634, filed on Jul. 22, 2022, which is based on, and claims benefit of priority to, Chinese Application No. 201911379639.4, filed on Dec. 27, 2019. The disclosures of International Patent Application No. PCT/CN2020/103634 and Chinese Application No. 201911379639.4 are hereby incorporated by reference in their entireties.

### TECHNICAL FIELD

The present disclosure relates to the field of artificial intelligence, and more particularly, to a three-dimensional target detection and model training method and device, and a storage medium.

### BACKGROUND

With development of artificial intelligence technologies such as neural networks and deep learning, the way of training a neural network model and using the trained neural network model to complete a task such as target detection has gradually gained popularity.

However, an existing neural network model is generally designed with a two-dimensional image as a detection object. A three-dimensional image such as a Magnetic Resonance Imaging (MRI) image often has to be split into two-dimensional planar images for further processing, thereby losing some spatial information and structural information in the three-dimensional image. Therefore, it is difficult to directly detect a three-dimensional target in a three-dimensional image.

### SUMMARY

The present disclosure is to provide a three-dimensional target detection and model training method and device, and a storage medium, capable of directly detecting a three-dimensional target and reducing a detection difficulty thereof.

Embodiments of the present disclosure provide a training method for training a three-dimensional target detection model, including: acquiring a sample three-dimensional image, where the sample three-dimensional image is labeled with actual location information of an actual region of a three-dimensional target; acquiring one or more pieces of prediction region information corresponding to one or more sub-images of the sample three-dimensional image by performing target detection on the sample three-dimensional image using the three-dimensional target detection model, where each piece of the prediction region information includes prediction confidence and prediction location information of a prediction region; determining a loss value of the three-dimensional target detection model using the actual location information and the one or more pieces of the prediction region information; and adjusting a parameter of the three-dimensional target detection model using the loss value, thereby acquiring a model for performing 3D target detection on a 3D image through training, without having to convert the 3D image into a 2D planar image for subsequent target detection. Therefore, the spatial information and structural information of the three-dimensional target are effectively retained, thereby detecting a three-dimensional target directly. When performing target detection with the three-dimensional target detection model, prediction region information of one or more sub-images of a three-dimensional image is acquired, thereby implementing three-dimensional target detection in one or more sub-images of the three-dimensional image, lowering difficulty in three-dimensional target detection.

In some embodiments, there are a preset number of pieces of the prediction region information. The preset number may match an output size of the three-dimensional target detection model. The determining the loss value of the three-dimensional target detection model using the actual location information and the one or more pieces of the prediction region information may include: generating, using the actual location information, the preset number of pieces of actual region information corresponding respectively to the preset number of the one or more sub-images, where each piece of the actual region information includes the actual location information and actual confidence, where actual confidence corresponding to a sub-image where a preset point of the actual region is located is a first value, where actual confidence corresponding to the remaining of the one or more sub-images is a second value, where the second value is less than the first value; acquiring a location loss value using the actual location information and the prediction location information of the preset number of the one or more sub-images; acquiring a confidence loss value using the actual confidence of the preset number of the one or more sub-images and corresponding prediction confidence; and acquiring the loss value of the three-dimensional target detection model based on the location loss value and the confidence loss value. Therefore, the preset number of pieces of actual region information corresponding to the preset number of the one or more sub-images is generated via the actual location information, such that loss computation is performed on the basis of the preset number of pieces of the actual region information and the corresponding prediction region information, thereby lowering complexity of loss computation.

In some embodiments, the actual location information includes an actual region size and an actual preset point location of the actual region. The prediction location information may include a prediction region size and a prediction preset point location of the prediction region. Acquiring the location loss value using the actual location information and the prediction location information of the preset number of the one or more sub-images may include: acquiring a first location loss value by performing computation on the actual preset point location of the preset number of the one or more sub-images and a corresponding prediction preset point location using a Binary Cross Entropy function; and acquiring a second location loss value by performing computation on the actual region size of the preset number of the one or more sub-images and a corresponding prediction region size using a Mean Square Error (MSE) function. Acquiring the confidence loss value using the actual confidence of the preset number of the one or more sub-images and the corresponding prediction confidence may include: acquiring the confidence loss value by performing computation on the actual confidence of the preset number of the one or more sub-images and the corresponding prediction confidence using the Binary Cross Entropy function. Acquiring the loss value of the three-dimensional target detection model based on the location loss value and the confidence loss value may include: acquiring the loss value of the three-dimensional target detection model by weighting the first location loss value, the second location loss value, and the confidence loss value. Therefore, by computing the first location loss value between the actual preset point location and the prediction preset point location, the second location loss value between the actual region size and the prediction region size, and the confidence loss value between the actual confidence and the prediction confidence, and finally weighting the loss values, the loss value of the 3D target detection model is acquired accurately and comprehensively, thereby adjusting a model parameter accurately, thus speeding up model training, improving accuracy of the three-dimensional target detection model.

In some embodiments, the training method further includes: before determining the loss value of the three-dimensional target detection model using the actual location information and the one or more pieces of the prediction region information, constraining a value of the actual location information, one or more pieces of the prediction location information, and the prediction confidence to a preset numerical range. Determining the loss value of the three-dimensional target detection model using the actual location information and the one or more pieces of the prediction region information may include: determining the loss value of the three-dimensional target detection model using the one or more pieces of the prediction region information and the actual location information as constrained. Therefore, before determining the loss value of the three-dimensional target detection model using the actual location information and the one or more pieces of the prediction region information, a value of the actual location information, one or more pieces of the prediction location information, and the prediction confidence are constrained to a preset numerical range. The loss value of the three-dimensional target detection model is determined using the one or more pieces of the prediction region information and the actual location information as constrained, effectively avoiding any network shock that may occur during training, improving a convergence speed.

In some embodiments, the actual location information includes an actual region size and an actual preset point location of the actual region. The prediction location information may include a prediction region size and a prediction preset point location of the prediction region. Constraining the value of the actual location information to the preset numerical range may include: acquiring a first ratio of the actual region size to a preset size, and taking a logarithm of the first ratio as a constrained actual region size; and acquiring a second ratio of the actual preset point location to an image size of the one or more sub-images, and taking a decimal part of the second ratio as the actual preset point location constrained. Constraining the one or more pieces of the prediction location information and the prediction confidence to the preset numerical range may include: mapping one or more of the prediction preset point location and the prediction confidence respectively to the preset numerical range using a preset mapping function. Therefore, by acquiring a first ratio of the actual region size to a preset size, and taking a logarithm of the first ratio as a constrained actual region size; acquiring a second ratio of the actual preset point location to an image size of the one or more sub-images, and taking a decimal part of the second ratio as the actual preset point location constrained; and mapping one or more of the prediction preset point location and the prediction confidence respectively to the preset numerical range using a preset mapping function, constraining is performed through mathematical operation or function mapping, thereby lowering complexity in constraining.

In some embodiments, acquiring the second ratio of the actual preset point location to the image size of the one or more sub-images includes: computing a third ratio of an image size of the sample three-dimensional image to a number of the one or more sub-images, and acquiring the second ratio as a ratio of the actual preset point location to the third ratio. Therefore, by computing a third ratio of an image size of the sample three-dimensional image to a number of the one or more sub-images, the image size of the sub-images is acquired, thereby lowering complexity in computing the second ratio.

In some embodiments, the preset numerical range is a range from 0 to 1; and/or, the preset size is an average of region sizes of actual regions of multiple sample three-dimensional images. Therefore, by setting the preset numerical range to that from 0 to 1, model convergence is accelerated; by setting the preset size as an average of region sizes of actual regions of multiple sample three-dimensional images, constrained actual region size is not too large or too small, thereby avoiding any shock at an initial stage of training or even a failure in convergence, improving model quality.

In some embodiments, the training method further includes at least one of pretreatment steps as follows: before acquiring the one or more pieces of the prediction region information by performing target detection on the sample three-dimensional image using the three-dimensional target detection model, converting the sample three-dimensional image into a Red, Green, Blue (RGB) color channel image; scaling the sample three-dimensional image to a set image size; or performing normalization and standardization processing on the sample three-dimensional image. Therefore, by converting the sample three-dimensional image into an RGB color channel image, the visual effect of target detection is improved. By scaling the sample three-dimensional image to a set image size, the 3D image is made to match the input size of the model as much as possible, thereby improving the model training effect. By performing normalization and standardization processing on the sample three-dimensional image, the model convergence speed during training is improved.

Embodiments of the present disclosure provide a three-dimensional target detecting method, including: acquiring a three-dimensional image for detection; and acquiring target region information corresponding to a three-dimensional target in the three-dimensional image for detection by performing target detection on the three-dimensional image for detection using a three-dimensional target detection model. The three-dimensional target detection model is acquired through a foregoing training method for training a three-dimensional target detection model. Therefore, with a three-dimensional target detection model trained by a training method for training a three-dimensional target detection model, a 3D target in a 3D image is detected, while lowering difficulty in 3D target detection.

Embodiments of the present disclosure provide a training device for training a three-dimensional target detection model, including an image acquiring module, a target detecting module, a loss determining module, and a parameter adjusting module. The image acquiring module is configured to acquire a sample three-dimensional image. The sample three-dimensional image is labeled with actual location information of an actual region of a three-dimensional target. The target detecting module is configured to acquire one or more pieces of prediction region information corresponding to one or more sub-images of the sample three-dimensional image by performing target detection on the sample three-dimensional image using the three-dimensional target detection model. Each piece of the prediction region information includes prediction confidence and prediction location information of a prediction region. The loss determining module is configured to determine a loss value of the three-dimensional target detection model using the actual location information and the one or more pieces of the prediction region information. The parameter adjusting module is configured to adjust a parameter of the three-dimensional target detection model using the loss value.

Embodiments of the present disclosure provide a three-dimensional target detecting device, including an image acquiring module and a target detecting module. The image acquiring module is configured to acquire a three-dimensional image for detection. The target detecting module is configured to acquire target region information corresponding to a three-dimensional target in the three-dimensional image for detection by performing target detection on the three-dimensional image for detection using a three-dimensional target detection model. The three-dimensional target detection model is acquired through a foregoing training device for training a three-dimensional target detection model.

Embodiments of the present disclosure provide an electronic equipment, including a memory and a processor coupled to each other. The processor is configured to execute program instructions stored in the memory to implement a foregoing training method for training a three-dimensional target detection model, or implement a foregoing three-dimensional target detecting method.

Embodiments of the present disclosure provide a computer-readable storage medium, having stored thereon program instructions which, when executed by a processor, implement a foregoing training method for training a three-dimensional target detection model, or implement a foregoing three-dimensional target detecting method.

Embodiments of the present disclosure provide a computer program, including a computer-readable code which, when run in an electronic equipment, allows a processor in the electronic equipment to implement a foregoing training method for training a three-dimensional target detection model implemented by a server in one or more foregoing embodiments, or implement a foregoing three-dimensional target detecting method implemented by a server in one or more foregoing embodiments.

Embodiments of the present disclosure provide a three-dimensional target detection and model training method and device, equipment, and a storage medium. The acquired sample 3D image is labeled with the actual location information of the actual region of a 3D target. Target detection is performed on the sample three-dimensional image using the three-dimensional target detection model, acquiring one or more pieces of prediction region information corresponding to one or more sub-images of the sample three-dimensional image. Each piece of the prediction region information includes prediction confidence and prediction location information of a prediction region corresponding to a sub-image of the sample three-dimensional image. Then, a loss value of the three-dimensional target detection model is determined using the actual location information and the one or more pieces of the prediction region information. A parameter of the three-dimensional target detection model is adjusted using the loss value, thereby acquiring a model for performing 3D target detection on a 3D image through training, without having to convert the 3D image into a 2D planar image for subsequent target detection. Therefore, the spatial information and structural information of the three-dimensional target are effectively retained, thereby detecting a three-dimensional target directly. When performing target detection with the three-dimensional target detection model, prediction region information of one or more sub-images of a three-dimensional image is acquired, thereby implementing three-dimensional target detection in one or more sub-images of the three-dimensional image, lowering difficulty in three-dimensional target detection.

### BRIEF DESCRIPTION OF THE DRAWINGS

FIG. 1A is a diagram of system architecture of a three-dimensional target detection and model training method according to an embodiment of the present disclosure.

FIG. 1B is a flowchart of a training method for training a three-dimensional target detection model according to an embodiment of the present disclosure.

FIG. 2 is a flowchart of S13 in FIG. 1B according to an embodiment.

FIG. 3 is a flowchart of constraining a value of actual location information to a preset numerical range according to an embodiment.

FIG. 4 is a flowchart of a three-dimensional target detecting method according to an embodiment of the present disclosure.

FIG. 5 is a block diagram of a training device for training a three-dimensional target detection model according to an embodiment of the present disclosure.

FIG. 6 is a block diagram of a three-dimensional target detecting device according to an embodiment of the present disclosure.

FIG. 7 is a block diagram of an electronic equipment according to an embodiment of the present disclosure.

FIG. 8 is a block diagram of a computer-readable storage medium according to an embodiment of the present disclosure.

### DETAILED DESCRIPTION

With the rise of technologies such as neural networks and deep learning, image processing methods based on neural networks have also emerged.

With a first type of the methods, a detection region, such as a lesion region, is segmented from the rest of a two-dimensional image using a neural network. However, by applying a method for segmenting a two-dimensional image directly to a scene of three-dimensional image processing, some spatial information and structural information in a three-dimensional image will be lost.

With a second type of the methods, a detection region, such as a breast tumor region, is segmented from the rest of a three-dimensional image using a neural network. First, deep learning is used to locate a breast tumor in the three-dimensional image. Then, region growth of the breast tumor region is used to cut at a tumor boundary. Alternatively, first, a three-dimensional U-Net is used to extract image features of a brain MRI image. Then, a high-dimensional vector non-local mean attention model is used to redistribute the image features. Finally, a brain tissue segmentation result is acquired. With this type of method, it is difficult to accurately segment a blurred region in an image when image quality is poor, which will affect accuracy of a segmentation result.

With a third type of the methods, a detection region of a two-dimensional image is identified using a neural network. However, the methods are to operate on a two-dimensional image. Alternatively, target detection is performed on a detection region using a three-dimensional neural network. However, with this type of method, a detection region is generated directly by the neural network, and the neural network converges at a low speed during training, with a low precision.

From the three types of methods, it may be seen that in related art, three-dimensional image processing technology is immature, presenting problems such as a poor feature extraction effect and few application. In addition, a target detecting method in related art is suitable for processing a two-dimensional planar image. When applied to three-dimensional image processing, there will be problems such as losing some image spatial information and structural information.

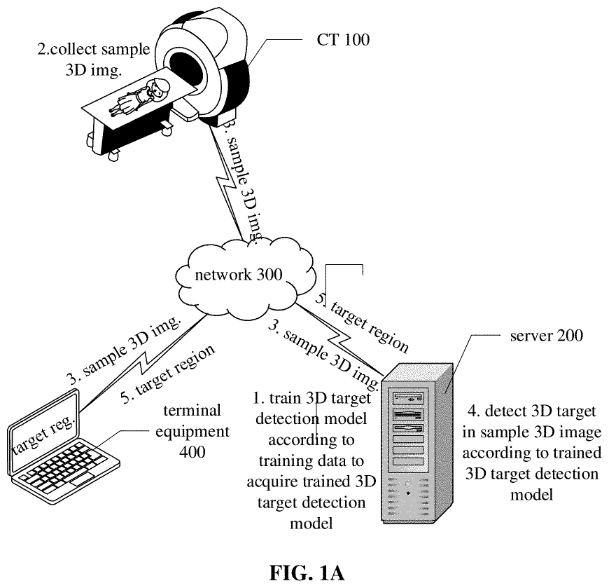

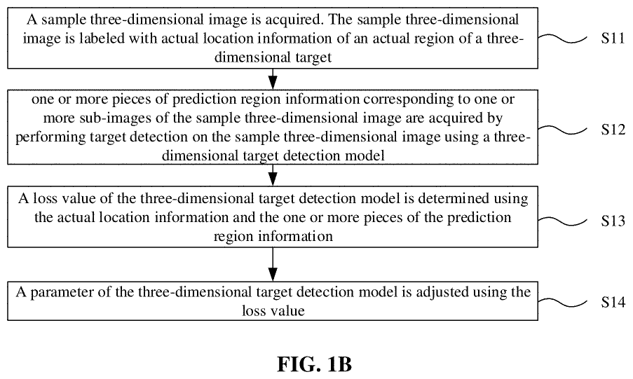

FIG. 1A is a diagram of system architecture of a three-dimensional target detection and model training method according to an embodiment of the present disclosure. As shown in FIG. 1A, the system architecture includes a CT instrument 100, a server 200, a network 300, and terminal equipment 400. To support an exemplary application, the CT instrument 100 may be connected to the terminal equipment 400 through the network 300. The terminal equipment 400 may be connected to the server 200 through the network 300. The CT instrument 100 may be used to collect a CT image. For example, it may be a terminal that may scan a certain thickness of a certain part of a human body, such as an X-ray CT instrument or a y-ray CT instrument, etc. The terminal equipment 400 may be equipment with a screen display function, such as a notebook computer, a tablet computer, a desktop computer, dedicated message equipment, etc. The network 300 may be a wide area network or a local area network, or a combination of the two, and implement data transmission using a wireless link.

Based on the three-dimensional target detection and model training method according to embodiments of the present disclosure, the server 200 may acquire a sample three-dimensional image; acquire one or more pieces of prediction region information corresponding to one or more sub-images of the sample three-dimensional image by performing target detection on the sample three-dimensional image using the three-dimensional target detection model; determine a loss value of the three-dimensional target detection model using the actual location information and the one or more pieces of the prediction region information; and adjust a parameter of the three-dimensional target detection model using the loss value. In addition, it may acquire target region information corresponding to a three-dimensional target in the three-dimensional image for detection by performing target detection on a three-dimensional image for detection using a three-dimensional target detection model. The sample three-dimensional image may be a lung CT image of a patient or a person that has received medical examination collected by a CT instrument 100 of a hospital, a medical examination center, and the like. The server 200 may acquire, from the terminal equipment 400, the sample three-dimensional image collected by the CT instrument 100 as the sample three-dimensional image. It may also acquire the sample three-dimensional image from the CT instrument. It may also acquire the sample three-dimensional image from the network.

The server 200 may be a stand-alone physical server, a distributed system or a server cluster composed of multiple physical servers, or a cloud server based on cloud technology. Cloud technology refers to a hosting technology that unifies a series of resources such as hardware, software, a network, etc., in a wide area network or a local area network, implementing data computation, storage, processing and sharing. As an example, having acquired a three-dimensional image for detection (e.g., a lung CT image), the server 200 performs target detection on the three-dimensional image for detection according to a trained three-dimensional target detection model, acquiring target region information corresponding to a three-dimensional target in the three-dimensional image for detection. Then, the server 200 returns the target region information detected to the terminal equipment 400, where the returned information is displayed, so as to be viewed by medical staff.

A solution of embodiments of the present disclosure is elaborated below with reference to the drawings accompanying the specification.

In the following description, for purpose of illustration rather than limiting, specifics such as a specific system structure, a specific interface, specific technology, etc., are proposed for a thorough understanding of the present disclosure.

Terms “system” and “network” herein are often used interchangeably herein. A term “and/or” herein describes but an association between associated objects, indicating three possible relationships. For example, by a1 and/or b1, it may mean that there are three cases, namely, existence of but a1, existence of both a1 and b1, and existence of but b1. A slash mark “/” herein generally denotes an “or” relationship between two associated objects that come respectively before and after the mark per se. In addition, “multiple” herein means two or more than two. Please refer to FIG. 1B. FIG. 1B is a flowchart of a training method for training a three-dimensional target detection model according to an embodiment of the present disclosure. As shown in FIG. 1B, the method may include steps as follows.

In S11, a sample three-dimensional image is acquired. The sample three-dimensional image is labeled with actual location information of an actual region of a three-dimensional target.

In an implementation scene, in order to detect a three-dimensional target such as a human body part, a sample three-dimensional image may be a nuclear magnetic resonance image. In addition, the sample three-dimensional image may also be a three-dimensional image acquired by three-dimensional reconstruction using a Computed Tomography (CT) image and a Type B Ultrasonic image, which is not limited here. The human body part may include but is not limited to: the anterior cruciate ligament, the pituitary gland and the like. There may be a three-dimensional target of another type, such as a diseased tissue, and so on, examples of which will not be enumerated one by one.

In an implementation scene, in order to improve accuracy of a trained three-dimensional target detection model, there may be multiple, such as 200, 300, 400, etc., sample three-dimensional images, which number is not limited here.

In an implementation scene, to match a sample 3D image to the input of a 3D target detection model, after a sample 3D image has been acquired, it may also be preprocessed. The preprocessing may be to scale the sample three-dimensional image to a set image size. The set image size may be consistent with an input size of the three-dimensional target detection model. For example, the original size of the sample 3D image may be 160*384*384. If the input size of the 3D target detection model is 160*160*160, then the sample 3D image may be scaled to 160*160*160 accordingly. In addition, in order to improve the convergence speed of the model during training, normalization processing and standardization processing may also be performed on the sample three-dimensional image. Alternatively, in order to improve a target detection effect, the sample 3D image may also be converted into a Red, Green, Blue (RGB) color channel image.

In S12, target detection is performed on the sample three-dimensional image using a three-dimensional target detection model, acquiring one or more pieces of prediction region information corresponding to one or more sub-images of the sample three-dimensional image.

In this embodiment, each piece of the prediction region information includes prediction confidence and prediction location information of a prediction region corresponding to a sub-image of the sample three-dimensional image. The prediction confidence is used to indicate credibility of a prediction result being a three-dimensional target. The higher the prediction confidence is, the higher the credibility of a prediction result.

In addition, the prediction region in this embodiment is a three-dimensional space region, such as a region enclosed by a cuboid, a region enclosed by a cube, and so on.

In an implementation scene, in order to meet an actual application need, a parameter of a three-dimensional target detection model may be set in advance, so that the three-dimensional target detection model may output prediction confidence and prediction location information of prediction regions corresponding to the preset number of sub-images of the sample three-dimensional image. That is, there may be a preset number of pieces of the prediction region information. The preset number is an integer greater than or equal to 1. The preset number may match an output size of the three-dimensional target detection model. For example, the image size of the three-dimensional image input to the three-dimensional target detection model is 160*160*160. By setting a network parameter in advance, the three-dimensional target detection model may be made to output prediction confidence and prediction location information of prediction regions corresponding to 10*10*10 sub-images of a size of 16*16*16. In addition, the preset number may also be set to 20*20*20, 40*40*40, etc., as needed, which is not limited here.

In an implementation scene, in order to facilitate implementation of target detection in three dimensions, the three-dimensional target detection model may be a three-dimensional convolutional neural network model, which may include a number of pooling layers and a number of convolutional layers connected at intervals, and a convolution kernel in a convolutional layer is a three-dimensional convolution kernel of a predetermined size. Taking the preset number of 10*10*10 as an example, please also refer to Table 1 below. Table 1 is a three-dimensional target detection model parameter setting table according to an embodiment.

TABLE 1
three-dimensional target detection model parameter setting table
according to an embodiment.

| net- | conv. | | | chan- | | |
|---|---|---|---|---|---|---|
| work | kernel | step | | nel | | output |
| layer | size | size | filling | # | input size | size |
| convl1 | 3 × 3 × 3 | 1 × 1 × 1 | 1 × 1 × 1 | 64 | 3 × 160 × | 64 × |
| + | | | | | 160 × 160 | 160 × |
| relu | | | | | | 160 × 160 |
| pool1 | 2 × 2 × 2 | 2 × 2 × 2 | 0 × 0 × 0 | / | 64 × 160 × | 64 × 80 × |
| | | | | | 160 × 160 | 80 × 80 |
| conv2 | 3 × 3 × 3 | 1 × 1 × 1 | 1 × 1 × 1 | 128 | 64 × 80 × | 128 × |
| + | | | | | 80 × 80 | 80 × |
| relu | | | | | | 80 × 80 |
| pool2 | 2 × 2 × 2 | 2 × 2 × 2 | 0 × 0 × 0 | / | 128 × 80 × | 128 × |
| | | | | | 80 × 80 | 40 × |
| | | | | | | 40 × 40 |
| conv3a | 3 × 3 × 3 | 1 × 1 × 1 | 1 × 1 × 1 | 256 | 128 × 40 × | 256 × |
| + | | | | | 40 × 40 | 40 × |
| relu | | | | | | 40 × 40 |
| conv3b | 3 × 3 × 3 | 1 × 1 × 1 | 1 × 1 × 1 | 256 | 256 × 40 × | 256 × |
| + | | | | | 40 × 40 | 40 × |
| relu | | | | | | 40 × 40 |
| pool3 | 2 × 2 × 2 | 2 × 2 × 2 | 0 × 0 × 0 | / | 256 × 40 × | 256 × |
| | | | | | 40 × 40 | 20 × |
| | | | | | | 20 × 20 |
| conv4a | 3 × 3 × 3 | 1 × 1 × 1 | 1 × 1 × 1 | 512 | 512 × 20 × | 512 × |
| + | | | | | 20 × 20 | 20 × |
| relu | | | | | | 20 × 20 |
| conv4b | 3 × 3 × 3 | 1 × 1 × 1 | 1 × 1 × 1 | 512 | 512 × 20 × | 512 × |
| + | | | | | 20 × 20 | 20 × |
| relu | | | | | | 20 × 20 |
| pool4 | 2 × 2 × 2 | 2 × 2 × 2 | 0 × 0 × 0 | / | 512 × 10 × | 512 × |
| | | | | | 10 × 10 | 10 × |
| | | | | | | 10 × 10 |
| conv5a | 3 × 3 × 3 | 1 × 1 × 1 | 1 × 1 × 1 | 512 | 512 × 10 × | 512 × |
| + | | | | | 10 × 10 | 10 × |
| relu | | | | | | 10 × 10 |
| conv5b | 3 × 3 × 3 | 1 × 1 × 1 | 1 × 1 × 1 | 7 | 512 × 10 × | 7 × 10 × |
| | | | | | 10 × 10 | 10 × 10 |

As shown in Table 1, the size of the three-dimensional convolution kernel may be 3*3*3. When the preset number is 10*10*10, the three-dimensional target detection model may include 8 convolutional layers. As shown in Table 1, the three-dimensional target detection model may include sequentially connected first convolutional layer and activation layer (i.e., conv1+relu in Table 1), first pooling layer (i.e., pool1 in Table 1), second convolutional layer and activation layer (i.e., conv2+relu in Table 1), second pooling layer (i.e., pool2 in Table 1), third convolutional layer and activation layer (i.e., conv3a+relu in Table 1), fourth convolutional layer and activation layer (i.e., conv3b+relu in Table 1), third pooling layer (i.e., pool3 in Table 1), fifth convolutional layer and activation layer (i.e., conv4a+relu in Table 1), sixth convolutional layer and activation layer (i.e., conv4b+relu in Table 1), fourth Pooling layer (i.e., pool4 in Table 1), seventh convolutional layer and activation layer (i.e., conv5a+relu in Table 1), and eighth convolutional layer (i.e., conv5b in Table 1). Through the setting, it is finally possible to predict a three-dimensional target in the 10*10*10 sub-images of the sample three-dimensional image, so that when a prediction preset point of a prediction region (such as the center point of the prediction region) of the three-dimensional target is in the region where a certain sub-image is located, the region where the sub-image is located is responsible for predicting the prediction region information of the three-dimensional target.

In S13, a loss value of the three-dimensional target detection model is determined using the actual location information and the one or more pieces of the prediction region information.

Here, computation may be performed on the actual location information and the prediction region information through at least one of a Binary Cross Entropy function and a Mean Square Error (MSE) function, acquiring the loss value of the three-dimensional target detection model. This is temporarily not elaborated here in the embodiment.

In S14, a parameter of the three-dimensional target detection model is adjusted using the loss value.

The loss value of the three-dimensional target detection model acquired using the actual location information and the prediction region information indicates a deviation between a prediction result, acquired by performing three-dimensional target detection using any current parameter of the three-dimensional target detection model, and a label actual location. Accordingly, the greater the loss value is, the greater the deviation between the two, that is, the greater the deviation between a current parameter and a target parameter. Therefore, a parameter of the three-dimensional target detection model may be adjusted through the loss value.

In an implementation scene, in order to acquire a stable and usable three-dimensional target detection model through training, after adjusting the any parameter of the three-dimensional target detection model, S12 and the subsequent steps may be performed again, thereby continuously performing the process of detection on the sample three-dimensional image, computing the loss value of the target detection model, and adjusting a parameter thereof, until a preset training end condition is met. In an implementation scene, the preset training end condition may include that the loss value is less than a preset loss threshold, and the loss value no longer decreases.

With the solution, the acquired sample 3D image is labeled with the actual location information of the actual region of a 3D target. Target detection is performed on the sample three-dimensional image using the three-dimensional target detection model, acquiring one or more pieces of prediction region information corresponding to one or more sub-images of the sample three-dimensional image. Each piece of the prediction region information includes prediction confidence and prediction location information of a prediction region corresponding to a sub-image of the sample three-dimensional image. Then, a loss value of the three-dimensional target detection model is determined using the actual location information and the one or more pieces of the prediction region information. A parameter of the three-dimensional target detection model is adjusted using the loss value, thereby acquiring a model for performing 3D target detection on a 3D image through training, without having to convert the 3D image into a 2D planar image for subsequent target detection. Therefore, the spatial information and structural information of the three-dimensional target are effectively retained. Accordingly, the image information of the three-dimensional image is fully mined, and the target detection is performed directly on the three-dimensional image, detecting a three-dimensional target. When performing target detection with the three-dimensional target detection model, prediction region information of one or more sub-images of a three-dimensional image is acquired, thereby implementing three-dimensional target detection in one or more sub-images of the three-dimensional image, lowering difficulty in three-dimensional target detection.

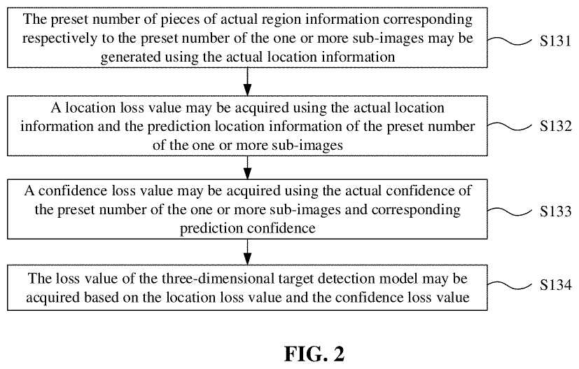

Please refer to FIG. 2. FIG. 2 is a flowchart of S13 in FIG. 1B according to an embodiment. In this embodiment, there may be a preset number of pieces of the prediction region information. The preset number may match an output size of the three-dimensional target detection model. As shown in FIG. 2, the following steps may be included.

In S131, the preset number of pieces of actual region information corresponding respectively to the preset number of the one or more sub-images may be generated using the actual location information.

Still take a 3D target detection model outputting prediction confidence and prediction location information of prediction regions of 10*10*10 sub-images as an example. Please refer to Table 1. Prediction region information output by the 3D target detection model may be deemed as a 7*10*10*10 vector. 10*10*10 represents a preset number of sub-images. 7 represents prediction location information of a three-dimensional target predicted by each sub-image (such as coordinates of a center point of a prediction region in directions x, y, and z, and a size of the prediction region in terms of a length, a width, and a height) and prediction confidence. Therefore, in order to make the existing label actual location information correspond to the prediction region information corresponding to the preset number of sub-images in a one-to-one correspondence, so as to compute the loss value later, this embodiment expands the actual location information to generate the preset number of pieces of actual region information corresponding to the preset number of sub-images. Each piece of the actual region information includes actual location information (such as coordinates of a center point of the actual region in directions x, y, and z, and a size of the actual region in terms of a length, a width, and a height) and actual confidence. Actual confidence corresponding to a sub-image where a preset point (such as the center point) of the actual region is located is a first value (such as 1). Actual confidence corresponding to any remaining sub-image is a second value (such as 0) less than the first value, so that the generated actual region information may also be regarded as a vector consistent with the size of the prediction region information.

In addition, in order to uniquely identify a three-dimensional target, prediction location information may include a prediction preset point location (such as the center point location of a prediction region) and a prediction region size. Corresponding to the prediction location information, the actual location information may also include an actual region size and an actual preset point location. (For example, corresponding to the prediction preset point location, the actual preset point location may also be the center point location of the actual region.)

In S132, a location loss value may be acquired using the actual location information and the prediction location information of the preset number of the one or more sub-images.

In this embodiment, a first location loss value may be acquired by performing computation on the actual preset point location of the preset number of the one or more sub-images and a corresponding prediction preset point location using a Binary Cross Entropy function. Refer to formula (1) for an expression for acquiring the first location loss value.

$$loss\_x = - \frac{1}{n} {\sum }_{i = 1}^{n} ( {X}_{gt} ( i ) * log ( {X}_{pr} ( i ) ) + ( 1 - {X}_{gt} ( i ) ) * log ( 1 - {X}_{pr} ( i ) ) ) \\ loss\_y = - \frac{1}{n} {\sum }_{i = 1}^{n} ( {Y}_{gt} ( i ) * log ( {Y}_{pr} ( i ) ) + ( 1 - {Y}_{gt} ( i ) ) * log ( 1 - {Y}_{pr} ( i ) ) ) \\ loss\_z = - \frac{1}{n} {\sum }_{i = 1}^{n} ( {Z}_{gt} ( i ) * log ( {Z}_{pr} ( i ) ) + ( 1 - {Z}_{gt} ( i ) ) * log ( 1 - {Z}_{pr} ( i ) ) ) ; \qquad ( 1 )$$

In the formula, n represents the preset number. Xₚᵣ(i), Yₚᵣ(i), Zₚᵣ(i) represent the prediction preset point location corresponding to the i-th sub-image, respectively. X_{gt}(i), Y_{gt}(i), Z_{gt}(i) represent the actual preset point location corresponding to the i-th sub-image, respectively. loss_x, loss_y, loss_ [symbol] represent sub-loss values of the first location loss value in directions x, y, and z, respectively.

In addition, a second location loss value may be acquired by performing computation on the actual region size of the preset number of the one or more sub-images and a corresponding prediction region size using a Mean Square Error (MSE) function. Refer to formula (2) for an expression for acquiring the second location loss value.

$$loss\_l = \frac{1}{n} {\sum }_{i = 1}^{n} {( {L}_{g t} ( i ) - {L}_{p r} ( i ) )}^{2} loss\_w = \frac{1}{n} {\sum }_{i = 1}^{n} {( {W}_{g t} ( i ) - {W}_{p r} ( i ) )}^{2} loss\_h = \frac{1}{n} {\sum }_{i = 1}^{n} {( {H}_{g t} ( i ) - {H}_{p r} ( i ) )}^{2} ; \qquad ( 2 )$$

In the formula, n represents the preset number. Lₚᵣ(i), Wₚᵣ(i), Hₚᵣ(i) represent the prediction region size corresponding to the i-th sub-image, respectively. L_{gt}(i), W_{gt}(i), H_{gt}(i) represent the actual region size corresponding to the i-th sub-image, respectively. loss_l, loss_w, loss_h represent sub-loss values of the second location loss value in directions l (length), w (width), and h (height), respectively.

In S133, a confidence loss value may be acquired using the actual confidence of the preset number of the one or more sub-images and corresponding prediction confidence.

Here, the confidence loss value may be acquired by performing computation on the actual confidence of the preset number of the one or more sub-images and the corresponding prediction confidence using the Binary Cross Entropy function. Refer to formula (3) for an expression for acquiring the confidence loss value.

$$loss\_p = - \frac{1}{n} {\sum }_{i = 1}^{n} ( {P}_{gt} ( i ) * log ( {P}_{p r} ( i ) ) + ( 1 - {P}_{gt} ( i ) ) * log ( 1 - {P}_{p r} ( i ) ) ) ; \qquad ( 3 )$$

In the formula, n is the preset number. Pₚᵣ(i) represents the prediction confidence corresponding to the i-th sub-image. P_{gt}(i) represents the actual confidence corresponding to the i-th sub-image. loss_p represents the confidence loss value.

In this embodiment, S132 and S133 may be performed in a sequential order. For example, S132 is performed first, and then S133 is performed. Alternatively, S133 is performed first, and then S132 is performed. S132 and S133 may also be performed at the same time, which is not limited here.

In S134, the loss value of the three-dimensional target detection model may be acquired based on the location loss value and the confidence loss value.

Here, the loss value of the three-dimensional target detection model may be acquired by weighting the first location loss value, the second location loss value, and the confidence loss value. Refer to formula (4) for an expression for acquiring the loss value of the three-dimensional target detection model.

loss=∂ₓloss_x+∂_{y}loss_y+ [symbol] loss_ [symbol] +∂ₗloss_l+∂_{w}loss_w+∂ₕloss_h+∂ₚloss_p (4);

In the formula, ∂ₓ, ∂_{y}, ∂_{z} represent weights corresponding respectively to sub-loss values of the first location loss value in directions x, y, and z. ∂ₗ, ∂_{w}, ∂ₕ represent weights corresponding respectively to sub-loss values of the second location loss value in directions l (length), w (width), and h (height). ∂ₚ indicates the weight corresponding to the confidence loss value.

In an implementation scene, the sum of ∂ₓ, ∂_{y}, [symbol] , ∂ₗ, ∂_{w}, ∂ₕ, ∂ₚ in the formula is 1. In an implementation scene, the sum of ∂ₓ, ∂_{y}, [symbol] , ∂ₗ, ∂_{w}, ∂ₕ, ∂ₚ in the formula is not 1. Accordingly, the loss value may be standardized by dividing the loss value acquired according to the formula by the sum of ∂ₓ, ∂_{y}, [symbol] , ∂ₗ, ∂_{w}, ∂ₕ, ∂ₚ in the formula.

Different from a foregoing embodiment, the preset number of pieces of actual region information corresponding respectively to the preset number of the one or more sub-images is generated via the actual location information, such that loss computation is performed on the basis of the preset number of pieces of the actual region information and the corresponding prediction region information, lowering complexity of loss computation.

In an implementation scene, reference metrics of actual region information and preset region information may not be consistent. For example, a prediction preset point location may be the deviation between the center point location of a prediction region and the center point location of a sub-image region where it is located, and a prediction region size may be the size of the prediction region with respect to a preset size (such as an anchor frame size); while the actual preset point location may be the location of the center point of the actual region in the sample 3D image, and the actual region size may be the length, the width, and the height of the actual region. Therefore, in order to speed up the convergence, before computing the loss value, a value of the actual location information, the one or more pieces of the prediction region information, and the prediction confidence are constrained to a preset numerical range (such as 0-1). Then, the loss value of the three-dimensional target detection model is determined using the one or more pieces of the prediction region information and the actual location information as constrained. Refer to any relevant step in a foregoing embodiment for computation of the loss value, which will not be repeated here.

Here, one or more pieces of prediction location information and prediction confidence may be mapped respectively to the preset numerical range using a preset mapping function. In this embodiment, the preset mapping function may be a sigmoid function, so that the prediction location information and the prediction confidence are mapped to the range of 0-1. Refer to formula (5) for an expression for mapping the prediction location information and the prediction confidence to the range 0-1.

$$σ ( {x}^{′} ) = \frac{1}{1 + {e}^{- {x}^{′}}} σ ( {y}^{′} ) = \frac{1}{1 + {e}^{- {y}^{′}}} σ ( {z}^{′} ) = \frac{1}{1 + {e}^{- {z}^{′}}} σ ( {p}^{′} ) = \frac{1}{1 + {e}^{- {p}^{′}}} ; \qquad ( 5 )$$

In the formula, (x′, y′, [symbol] ) resents a prediction preset point location in the prediction location information. σ(x′), σ(y′), σ( [symbol] ) represent the prediction preset point location in the prediction location information as constrained. p′ represents the prediction confidence. σ(p′) represents the prediction confidence as constrained.

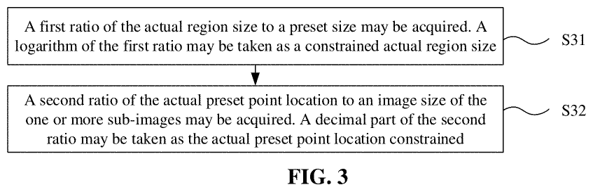

In addition, please also refer to FIG. 3. FIG. 3 is a flowchart of constraining a value of actual location information to a preset numerical range according to an embodiment. As shown in FIG. 3, the method may include steps as follows.

In S31, a first ratio of the actual region size to a preset size may be acquired. A logarithm of the first ratio may be taken as a constrained actual region size.

In this embodiment, the preset size may be set in advance by a user as needed, or may be an average of region sizes of actual regions of multiple sample three-dimensional images. For example, for N sample 3D images, the region size of the actual region of the jth sample three-dimensional image may be expressed as l_{gt}(j), w_{gt}(j), h_{gt}(j) in directions l (length), w (width), and h (height), respectively. Refer to formula (6) for expressions of the preset size in directions l (length), w (width), and h (height).

$${l}_{avg} = \frac{{\sum }_{j = 1}^{N} {l}_{gt} ( j )}{N} \\ {w}_{avg} = \frac{{\sum }_{j = 1}^{N} {w}_{gt} ( j )}{N} \\ {h}_{avg} = \frac{{\sum }_{j = 1}^{N} {h}_{gt} ( j )}{N} ; \qquad ( 6 )$$

In the formula, l_{avg}, w_{avg}, h_{avg} represent values of the preset size in directions l (length), w (width), and h (height), respectively.

On this basis, refer to formula (7) for expressions of the constrained actual region size in directions l (length), w (width), and h (height).

$${l}_{gt}^{′} = log ( \frac{{l}_{gt}}{{l}_{a v g}} ) {w}_{gt}^{′} = log ( \frac{{w}_{gt}}{{w}_{a v g}} ) {h}_{gt}^{′} = log ( \frac{{h}_{gt}}{{h}_{a v g}} ) ; \qquad ( 7 )$$

In the formula,

$$\frac{{l}_{gt}}{{l}_{avg}} , \frac{{w}_{gt}}{{w}_{avg}} , and \frac{{h}_{gt}}{{h}_{avg}}$$

represent the first ratio in directions l (length), w (width), and h (height), respectively. l_{gt}′, w_{gt}′, h_{gt}′ represent constrained actual sizes in directions l (length), w (width), and h (height), respectively.

After processing using the formula, the actual region size may be constrained to the value of the actual region size with respect to the average of all actual region sizes.

In S32, a second ratio of the actual preset point location to an image size of the one or more sub-images may be acquired. A decimal part of the second ratio may be taken as the actual preset point location constrained.

In this embodiment, a third ratio of an image size of the sample three-dimensional image to a number of the one or more sub-images may be taken as the image size of the sub-images, thereby acquiring the second ratio as a ratio of the actual preset point location to the third ratio. In an implementation scene, the number of the sub-images may be a preset number that matches the output size of the three-dimensional target detection model. Taking the preset number of 10*10*10 and the image size of the three-dimensional sample image of 160*160*160 as an example, the image size of the sub-images is 16, 16, 16 in directions l (length), w (width), and h (height), respectively. A preset number and an image size of the three-dimensional sample image of other values are similar, examples of which will not be enumerated one by one.

Here, the decimal part of the second ratio may be acquired as the difference between the second ratio and the rounding down of the second ratio. Refer to formula (8) for an expression for acquiring the decimal part.

$${x}_{gt}^{′} = \frac{{x}_{gt}}{{L}^{′}} - floor ( \frac{{x}_{gt}}{{L}^{′}} ) \\ {y}_{gt}^{′} = \frac{{y}_{gt}}{{W}^{′}} - floor ( \frac{{y}_{gt}}{{W}^{′}} ) \\ {z}_{gt}^{′} = \frac{{z}_{gt}}{{H}^{′}} - floor ( \frac{{z}_{gt}}{{H}^{′}} ) ; \qquad ( 8 )$$

In the formula, x_{gt}′, y_{gt}′, [symbol] _{gt}′ represent values of the actual preset point location constrained in directions x, y, and z, respectively. L′, W′, H′ represent sizes of the preset size in directions l (length), w (width), and h (height), respectively. x_{gt}, y_{gt}, [symbol] _{gt} represent values of the actual preset point location in directions x, y, and z. floor( [symbol] ) represents rounding down.

When the preset size is the image size of the sub-images, after the processing, the actual preset point location may be constrained to the relative location of the actual preset point in a sub-image.

In this embodiment, S31 and S32 may be performed in a sequential order. For example, S31 is performed first, and then S32 is performed. Alternatively, S32 is performed first, and then S31 is performed. S31 and S32 may also be performed at the same time, which is not limited here.

Different from a foregoing embodiment, before determining the loss value of the three-dimensional target detection model using the actual location information and the one or more pieces of the prediction region information, a value of the actual location information, one or more pieces of the prediction location information, and the prediction confidence are constrained to a preset numerical range. The loss value of the three-dimensional target detection model is determined using the one or more pieces of the prediction region information and the actual location information as constrained, effectively avoiding any network shock that may occur during training, improving a convergence speed.

In some embodiments, in order to improve the degree of automation of training, a script program may be used to execute steps in any of the embodiments. Here, steps in any of the embodiments may be executed through a Python language and a Pytorch framework. On this basis, an Adam optimizer may be used, a learning rate may be set to 0.0001, a batch size of a network may be set to 2, and a number of iterations (epoch) may be set to 50. The values of the learning rate, the batch size, and the number of iterations are only examples. In addition to the values listed in this embodiment, settings may also be done as needed, which is not limited here.

In some embodiments, in order to intuitively reflect a training result, the preset number of pieces of actual region information corresponding respectively to the preset number of the one or more sub-images may be generated using the actual location information. Each piece of the actual region information may include the actual location information. Refer to a relevant step in a foregoing embodiment. On this basis, an Intersection over Union (IoU) between the actual region and prediction regions corresponding to the preset number of the one or more sub-images may be computed using the actual location information and prediction location information corresponding to the preset number of the one or more sub-images. Then, the average of the preset number of IoUs may be compute, and taken as a Mean Intersection over Union (MIoU) in a training process. The greater the MIoU is, the higher a degree of a prediction region coinciding with the actual region, the more accurate the model. Here, in order to reduce difficulty in computation, it is also possible to compute the IoU on a coronal plane, a sagittal plane, and a cross section, respectively, examples of which will not be enumerated one by one.

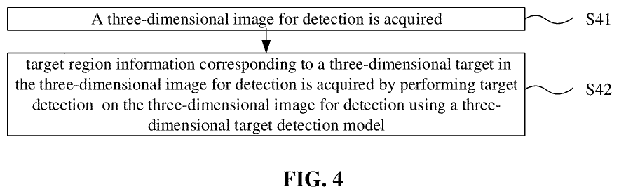

Please refer to FIG. 4. FIG. 4 is a flowchart of a three-dimensional target detecting method according to an embodiment. FIG. 4 is a flowchart of an embodiment of performing target detection using a three-dimensional target detection model trained by steps in any embodiment of the training method for training a three-dimensional target detection model. As shown in FIG. 4, the method includes steps as follows.

In S41, a three-dimensional image for detection is acquired.

Similar to a sample three-dimensional image, a three-dimensional image for detection may be a nuclear magnetic resonance image, or a three-dimensional image acquired by three-dimensional reconstruction using a CT image and a Type B Ultrasonic image, which is not limited here.

In S42, target detection is performed on the three-dimensional image for detection using a three-dimensional target detection model, acquiring target region information corresponding to a three-dimensional target in the three-dimensional image for detection.

In this embodiment, the three-dimensional target detection model is acquired using any foregoing training method for training a three-dimensional target detection model. Refer to steps in any embodiment of the training method for training a three-dimensional target detection model, which will not be repeated here.

Here, when target detection is performed on a three-dimensional image for detection using a three-dimensional target detection model, one or more pieces of prediction region information corresponding to one or more sub-images of the three-dimensional image for detection may be acquired. Each piece of the prediction region information may include prediction confidence and prediction location information of a prediction region. In an implementation scene, there are a preset number of one or more pieces of the prediction region information. The preset number matches an output size of the three-dimensional target detection model. Refer to a relevant step in a foregoing embodiment. After acquiring one or more pieces of the prediction region information corresponding to one or more sub-images of the three-dimensional image for detection, a highest prediction confidence may be counted. Target region information corresponding to a three-dimensional target in the three-dimensional image for detection may be determined using prediction location information corresponding to the highest prediction confidence. The prediction location information corresponding to the highest prediction confidence has the most reliable credibility. Therefore, the target region information corresponding to the three-dimensional target may be determined based on the prediction location information corresponding to the highest prediction confidence. Here, the target region information may be the prediction location information corresponding to the highest prediction confidence, including a prediction preset point location (such as the center point location of a prediction region), and a prediction region size. Performing three-dimensional target detection in one or more sub-images of the three-dimensional image for detection lowers difficulty in three-dimensional target detection.

In an implementation scene, before being input to a 3D target detection model for target detection, to match the input of the 3D target detection model, a three-dimensional image for detection may be scaled to a set image size. (The set image size may be consistent with an input size of the three-dimensional target detection model.) Then, after the target region information in the scaled three-dimensional image for detection has been acquired in such a mode, an acquired target region may be processed to cancel the effect of the scaling, thereby acquiring a target region in the three-dimensional image for detection.

With the solution, target detection is performed on a three-dimensional image for detection using a three-dimensional target detection model, acquiring target region information corresponding to a three-dimensional target in the three-dimensional image for detection. The three-dimensional target detection model is acquired using any foregoing training method for training a three-dimensional target detection model, without having to convert a 3D image into a 2D planar image for subsequent target detection. Therefore, the spatial information and structural information of a three-dimensional target are effectively retained, thereby implementing direct detection of a three-dimensional target.

Embodiments of the present disclosure provide a three-dimensional target detecting method, taking detection of an anterior cruciate ligament region in a knee MRI image based on three-dimensional convolution as an example. The detection is applied to a field of medical image computation-aided diagnosis. The method includes steps as follows.

In step 410, a three-dimensional knee MRI image including an anterior cruciate ligament region is acquired, and preprocessed.

For example, 424 sets of three-dimensional knee MRI images are acquired, and the format of the images may be .nii. The size of each image is 160*384*384.

Here, an example is given to illustrate how the image is preprocessed. First, the MRI images are converted into matrix data using a function package. Then, the matrix data, as single-channel data, are expanded to three-channel data. The size of the three-channel data is reduced to 3*160*160*160. The 3 is the number of RGB channels. Finally, normalization and standardization are performed on the size-reduced three-channel data, to complete preprocessing the images.

Here, pre-processed image data will be divided into a training set, a validation set, and a test set according to a ratio of 3:1:1.

In step 420, the pre-processed images are labeled manually, acquiring a real bounding box of the three-dimensional location of the anterior cruciate ligament region, including center point coordinates as well as a length, a width, and a height of the anterior cruciate ligament region.

For example, three views of a coronal plane, a sagittal plane, and a cross section of a preprocessed image may be viewed using software. The anterior cruciate ligament region is labeled manually, acquiring the bounding box of the three-dimensional location of the anterior cruciate ligament region. Coordinates of the center point and the length, the width, and the height of the region are denoted by (x_{gt}, y_{gt}, [symbol] _{gt}, l_{gt}, w_{gt}, h_{gt}) Averages of lengths, widths, and heights of all label bounding boxes are computed and taken as the preset size, denoted by (l_{avg}, w_{avg}, h_{avg}).

In step 430, a network for detecting an anterior cruciate ligament region based on three-dimensional convolution is constructed. Feature extraction is performed on the knee MRI image, acquiring a predicted value of the bounding box of the three-dimensional location of the anterior cruciate ligament region.

In an implementation scene, the image size of the three-dimensional knee MRI image input to the three-dimensional target detection model is 160*160*160, for example. Step 430 may include steps as follows.

In step 431, the three-dimensional knee MRI image is divided into 10*10*10 sub-images of an image size of 16*16*16. If the center of the anterior cruciate ligament region falls in a sub-image, the sub-image is used to predict the anterior cruciate ligament.

In step 432, 3*160*160*160 training set data are input to the detection network structure of Table 1, outputting 7*10*10*10 image features X_{ft}.

Here, each of the sub-images includes 7 predicted values. The predicted values include 6 predicted values (x′, y′, [symbol] , l′, w′, h′) of a three-dimensional location bounding box and prediction confidence p′ of the location bounding box.

In step 433, the 7 predicted values (x′, y′, [symbol] ′, l′, w′, h′, p′) of each sub-image are constrained to a preset numerical range using a preset mapping function.

Here, constraining the predicted values to a preset numerical range improves the convergence speed of the detection network and facilitate computing the loss function. Here, the preset mapping function may be a sigmoid function. In order to have the center point of the bounding box predicted by each sub-image fall inside the sub-image, thereby speeding up the convergence, the three predicted values (x′, y′, [symbol] ) of coordinates of the center point of the bounding box are mapped to the interval [0, 1] using the sigmoid function, serving as the relative location in the sub-image, specifically as shown in formula (5). Here, the prediction confidence p′ of the bounding box is mapped to the interval [0, 1] using the sigmoid function. The p′ represents the probability of a bounding box predicted by a sub-image being the actual location information of the anterior cruciate ligament in the MRI image, specifically as shown in formula (5).

In step 440, the loss function is optimized according to the actual region size and the preset size to train the network until it converges, acquiring a network that may detect the anterior cruciate ligament region accurately.

In an implementation scene, step 440 may include steps as follows.

In step 441, coordinates of the center point and the length, the width, and the height (x_{gt}, y_{gt}, [symbol] _{gt}, l_{gt}, w_{gt}, h_{gt}) of the bounding box of the manual label of the anterior cruciate ligament region are expanded to a vector of a size 7*10*10*10 to correspond to 10*10*10 sub-images.

Here, coordinates of the center point and the length, the width, and the height of the bounding box of each sub-image (x_{gt}, y_{gt}, [symbol] _{gt}, l_{gt}, w_{gt}, h_{gt}). True confidence p_{gt} corresponding to a sub-image where the center point of the anterior cruciate ligament region is located is 1. True confidence p_{gt} of any remaining sub-image is 0.

In step 442, actual values (x_{gt}, y_{gt}, [symbol] _{gt}, l_{gt}, w_{gt}, h_{gt}) of the sub-image are computed. The computation step includes steps as follows.

In step 4421, regarding true values (x_{gt}, y_{gt}, [symbol] _{gt}) of coordinates of the center point of the bounding box, the side length of each sub-image is taken as the unit 1. The relative value of the center point inside the sub-image is computed using formula (8).

In step 4422, logarithms of ratios of true values (l_{gt}, w_{gt}, h_{gt}) of the length, the width, and the height of the bounding box to the preset size (l_{avg}, w_{avg}, h_{avg}) are computed using formula (7), acquiring a processed true value vector X_{gt} of a size 7×10×10×10.

In step 443, for the processed predicted vector Xₚᵣ and true value vector X_{gt}, the loss function is computed using a Binary Cross Entropy function and a variance function, computation formulas being formulas (1) to (4). Xₚᵣ, Yₚᵣ, Zₚᵣ, Lₚᵣ, Wₚᵣ, Hₚᵣ, Pₚᵣ, respectively are a predicted vector of coordinates of the center point, the length, the width, the height, and confidence of a size S×S×S. X_{gt}, Y_{gt}, Z_{gt}, L_{gt}, W_{gt}, H_{gt}, P_{gt} respectively are the true value vector of coordinates of the center point, the length, the width, the height, and confidence of a size S×S×S. ∂ₓ, ∂_{y}, [symbol] , ∂ₗ, ∂_{w}, ∂ₕ, ∂ₚ are weights of components of the loss function, respectively.

In step 444, an experiment is performed based on the Python language and the Pytorch framework. During network training, an optimizer is selected, a learning rate is set to 0.0001, a batch size of the network is 2, and a number of iterations is 50.

In step 450, knee MRI test data are input to a trained network for detecting the anterior cruciate ligament region, acquiring a result of detecting the anterior cruciate ligament region.

In step 460, a MIoU is taken as an evaluation index for measuring an experimental result of the detection network.

Here, the MIoU measures the detection network by computing a ratio of Intersection over Union (IoU) of the two sets. In a three-dimensional target detecting method, the two sets are the actual region and the prediction region. Refer to formula (9) for an expression of MIoU.

$$I o U = \frac{{S}_{pr} ⋂ {S}_{gt}}{{S}_{pr} ⋃ {S}_{gt}} ; \qquad ( 9 )$$

Sₚᵣ is the area of the prediction region. S_{gt} is the area of the actual region.

Here, an experimental result of the detection network is measured using MIoU as shown in Table 2. Table 2 is IoU of a coronal plane, a sagittal plane, and a cross section.

TABLE 2
IoU of a coronal plane, a sagittal plane, and a cross section

| coronal plane IoU | sagittal plane IoU | cross section IoU |
|---|---|---|
| 67.8% | 76.2% | 69.2% |

With the solution, knee MRI test data are input to a trained network for detecting the anterior cruciate ligament region, acquiring a result of detecting the anterior cruciate ligament region. In this way, a three-dimensional knee MRI image is processed directly and the anterior cruciate ligament region is detected directly. The three-dimensional knee MRI image is divided into a plurality of sub-images. Seven predicted values of each sub-image are constrained to a preset numerical range using a preset mapping function. In this way, during detection, difficulty in detecting the anterior cruciate ligament region is reduced, network convergence is accelerated, and detection accuracy is improved. By dividing the three-dimensional knee MRI image into a number of sub-images, and constraining coordinates of the center point, the length, the width, the height, and confidence of a predicted bounding box output by the network using a preset mapping function, the center point of the predicted bounding box is made to fall within the sub-image where prediction is performed, and values of the length, the width, and the height are not too large or too small with respect to the preset size, avoiding any shock at an initial stage of network training or even a failure in network convergence. Feature extraction is performed on a knee MRI image using a detection network, thereby detecting the anterior cruciate ligament region in the image precisely, providing a basis for improving efficiency and accuracy in anterior cruciate ligament disease diagnosis. Therefore, it is possible to break through limitations relating to assisting diagnosis using a two-dimensional medical image, and to use a three-dimensional MRI image for medical image processing, with more data quantity and richer data information.

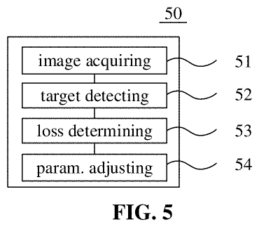

FIG. 5 is a block diagram of a training device 50 for training a three-dimensional target detection model according to an embodiment of the present disclosure. The training device 50 for training a three-dimensional target detection model includes: an image acquiring module 51, a target detecting module 52, a loss determining module 53, and a parameter adjusting module 54. The image acquiring module 51 is configured to acquire a sample three-dimensional image. The sample three-dimensional image is labeled with actual location information of an actual region of a three-dimensional target. The target detecting module 52 is configured to acquire one or more pieces of prediction region information corresponding to one or more sub-images of the sample three-dimensional image by performing target detection on the sample three-dimensional image using the three-dimensional target detection model. Each piece of the prediction region information includes prediction confidence and prediction location information of a prediction region. The loss determining module 53 is configured to determine a loss value of the three-dimensional target detection model using the actual location information and the one or more pieces of the prediction region information. The parameter adjusting module 54 is configured to adjust a parameter of the three-dimensional target detection model using the loss value. In an implementation scene, the three-dimensional target detection model is a three-dimensional convolutional neural network model. In an implementation scene, the sample three-dimensional image is a nuclear magnetic resonance image. The three-dimensional target may be a human body part.

With the solution, the acquired sample 3D image is labeled with the actual location information of the actual region of a 3D target. Target detection is performed on the sample three-dimensional image using the three-dimensional target detection model, acquiring one or more pieces of prediction region information corresponding to one or more sub-images of the sample three-dimensional image. Each piece of the prediction region information includes prediction confidence and prediction location information of a prediction region corresponding to a sub-image of the sample three-dimensional image. Then, a loss value of the three-dimensional target detection model is determined using the actual location information and the one or more pieces of the prediction region information. A parameter of the three-dimensional target detection model is adjusted using the loss value, thereby acquiring a model for performing 3D target detection on a 3D image through training, without having to convert the 3D image into a 2D planar image for subsequent target detection. Therefore, the spatial information and structural information of the three-dimensional target are effectively retained, thereby detecting a three-dimensional target directly. When performing target detection with the three-dimensional target detection model, prediction region information of one or more sub-images of a three-dimensional image is acquired, thereby implementing three-dimensional target detection in one or more sub-images of the three-dimensional image, lowering difficulty in three-dimensional target detection.

In some embodiments, there are a preset number of pieces of the prediction region information. The preset number may match an output size of the three-dimensional target detection model. The loss determining module 53 may include an actual region information generating sub-module configured to generate, using the actual location information, the preset number of pieces of actual region information corresponding respectively to the preset number of the one or more sub-images. Each piece of the actual region information may include the actual location information and actual confidence. Actual confidence corresponding to a sub-image where a preset point of the actual region is located may be a first value. Actual confidence corresponding to the remaining of the one or more sub-images may be a second value. The second value is less than the first value. The loss determining module 53 may include a location loss computing sub-module configured to acquire a location loss value using the actual location information and the prediction location information of the preset number of the one or more sub-images. The loss determining module 53 may include a confidence loss computing sub-module configured to acquire a confidence loss value using the actual confidence of the preset number of the one or more sub-images and corresponding prediction confidence. The loss determining module 53 may include a model loss computing sub-module configured to acquire the loss value of the three-dimensional target detection model based on the location loss value and the confidence loss value.

Different from a foregoing embodiment, the preset number of pieces of actual region information corresponding respectively to the preset number of the one or more sub-images is generated via the actual location information, such that loss computation is performed on the basis of the preset number of pieces of the actual region information and the corresponding prediction region information, lowering complexity of loss computation.

In some embodiments, the actual location information includes an actual region size and an actual preset point location of the actual region. The prediction location information may include a prediction region size and a prediction preset point location of the prediction region. The location loss computing sub-module may include a first location loss computing part configured to acquire a first location loss value by performing computation on the actual preset point location of the preset number of the one or more sub-images and a corresponding prediction preset point location using a Binary Cross Entropy function. The location loss computing sub-module may include a second location loss computing part configured to acquire a second location loss value by performing computation on the actual region size of the preset number of the one or more sub-images and a corresponding prediction region size using a Mean Square Error (MSE) function. The confidence loss computing sub-module may be configured to acquire the confidence loss value by performing computation on the actual confidence of the preset number of the one or more sub-images and the corresponding prediction confidence using the Binary Cross Entropy function. The model loss computing sub-module may be configured to acquire the loss value of the three-dimensional target detection model by weighting the first location loss value, the second location loss value, and the confidence loss value.

In some embodiments, the training device 50 for training a three-dimensional target detection model further includes a constraining module configured to constrain a value of the actual location information, the one or more pieces of the prediction location information, and the prediction confidence to a preset numerical range. The loss determining module 53 may be configured to determine the loss value of the three-dimensional target detection model using the one or more pieces of the prediction region information and the actual location information as constrained. In an implementation scene, the preset numerical range is a range from 0 to 1.

Different from a foregoing embodiment, the training device 50 further includes a constraining module configured to constrain a value of the actual location information, the one or more pieces of the prediction location information, and the prediction confidence to a preset numerical range. The loss determining module 53 may be further configured to determine the loss value of the three-dimensional target detection model using the one or more pieces of the prediction region information and the actual location information as constrained, effectively avoiding any network shock that may occur during training, improving a convergence speed.

In some embodiments, the actual location information includes an actual region size and an actual preset point location of the actual region. The prediction location information may include a prediction region size and a prediction preset point location of the prediction region. The constraining module may include a first constraining sub-module configured to acquire a first ratio of the actual region size to a preset size, and take a logarithm of the first ratio as a constrained actual region size. The constraining module may include a second constraining sub-module configured to acquire a second ratio of the actual preset point location to an image size of the one or more sub-images, and take a decimal part of the second ratio as the actual preset point location constrained. The constraining module may include a third constraining sub-module configured to map one or more of the prediction preset point location and the prediction confidence respectively to the preset numerical range using a preset mapping function. In an implementation scene, the preset size is an average of region sizes of actual regions of multiple sample three-dimensional images.

In some embodiments, the second constraining sub-module is further configured to compute a third ratio of an image size of the sample three-dimensional image to a number of the one or more sub-images, and acquire the second ratio as a ratio of the actual preset point location to the third ratio.

In some embodiments, the preset numerical range is a range from 0 to 1; and/or, the preset size is an average of region sizes of actual regions of multiple sample three-dimensional images. The training device 50 for training a three-dimensional target detection model may further include a preprocessing module configured to convert the sample three-dimensional image into a Red, Green, Blue (RGB) color channel image; scale the sample three-dimensional image to a set image size; and perform normalization and standardization processing on the sample three-dimensional image.

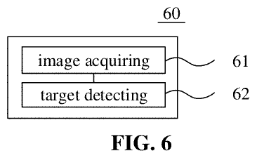

Please refer to FIG. 6. FIG. 6 is a block diagram of a three-dimensional target detecting device 60 according to an embodiment of the present disclosure. The three-dimensional target detecting device 60 includes an image acquiring module 61 and a target detecting module 62. The image acquiring module 61 is configured to acquire a three-dimensional image for detection. The target detecting module 62 is configured to acquire target region information corresponding to a three-dimensional target in the three-dimensional image for detection by performing target detection on the three-dimensional image for detection using a three-dimensional target detection model. The three-dimensional target detection model is acquired using any foregoing training method for training a three-dimensional target detection model.

With the solution, target detection is performed on a three-dimensional image for detection using a three-dimensional target detection model, acquiring target region information corresponding to a three-dimensional target in the three-dimensional image for detection. The three-dimensional target detection model is acquired using a training device for training a three-dimensional target detection model in any foregoing embodiment of a training device for training a three-dimensional target detection model, without having to convert a 3D image into a 2D planar image for subsequent target detection. Therefore, the spatial information and structural information of a three-dimensional target are effectively retained, thereby implementing direct detection of a three-dimensional target.

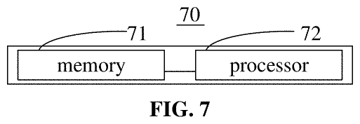

Please refer to FIG. 7. FIG. 7 is a block diagram of an electronic equipment 70 according to an embodiment of the present disclosure. The electronic equipment 70 includes a memory 71 and a processor 72 that are coupled to each other. The processor 72 is configured to execute program instructions stored in the memory 71 to implement the steps of any foregoing embodiment of a training method for training a three-dimensional target detection model, or to implement the steps of any foregoing embodiment of a three-dimensional target detecting method. In an implementation scene, the electronic equipment 70 may include but is not limited to: a microcomputer, a server, etc. In addition, the electronic equipment 70 may also include mobile equipment such as a notebook computer, a tablet computer, etc., which is not limited herein.

Here, the processor 72 is configured to control itself and the memory 71 to implement the steps of any foregoing embodiment of a training method for training a three-dimensional target detection model, or implement any foregoing embodiment of a three-dimensional target detecting method. The processor 72 may also be referred to as a Central Processing Unit (CPU). The processor 72 may be an integrated circuit chip with signal processing capacity. The processor 72 may also be a general-purpose processor, a Digital Signal Processor (DSP), an Application Specific Integrated Circuit (ASIC), a Field-Programmable Gate Array (FPGA), or another Programmable logic device, a discrete gate, or a transistor logic device, a discrete hardware component. A general-purpose processor may be a microprocessor or the processor may also be any conventional processor or the like. In addition, the processor 72 may be jointly implemented by an integrated circuit chip.

With the solution, a 3D image does not have to be converted into a 2D planar image for subsequent target detection. Therefore, the spatial information and structural information of the three-dimensional target are effectively retained, thereby detecting a three-dimensional target directly. When performing target detection with the three-dimensional target detection model, prediction region information of one or more sub-images of a three-dimensional image is acquired, thereby implementing three-dimensional target detection in one or more sub-images of the three-dimensional image, lowering difficulty in three-dimensional target detection.

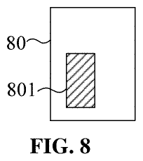

Please refer to FIG. 8. FIG. 8 is a block diagram of a computer-readable storage medium 80 according to an embodiment of the present disclosure. The computer-readable storage medium 80 stores program instructions 801 that may be executed by a processor. The program instructions 801 are configured to implement the steps of any foregoing embodiment of a training method for training a three-dimensional target detection model, or to implement the steps of any foregoing embodiment of a three-dimensional target detecting method.

With the solution, a 3D image does not have to be converted into a 2D planar image for subsequent target detection. Therefore, the spatial information and structural information of the three-dimensional target are effectively retained, thereby detecting a three-dimensional target directly. When performing target detection with the three-dimensional target detection model, prediction region information of one or more sub-images of a three-dimensional image is acquired, thereby implementing three-dimensional target detection in one or more sub-images of the three-dimensional image, lowering difficulty in three-dimensional target detection.

In a number of embodiments provided in the present disclosure, it should be understood that disclosed method and device may be implemented in other ways. For example, described device implementation is merely exemplary. For example, module or part division is merely logic function division and there may be another division in actual implementation. For example, parts or components can be combined, or integrated into another system, or some features/characteristics may be omitted or skipped. Furthermore, the coupling, or direct coupling or communicational connection illustrated or discussed herein may be implemented through indirect coupling or communicational connection among some interfaces, devices, or parts, and may be electrical, mechanical, or of another form.

Parts described as separate components may or may not be physically separated. Components shown as parts may be or may not be physical parts. They may be located in one place, or distributed on network parts. Some or all of the parts may be selected to achieve the purpose of a solution of the present embodiments as needed. In addition, various functional parts in embodiments of the present disclosure may be integrated in one processing part, or exist as separate physical parts respectively. Alternatively, two or more such parts may be integrated in one part. The integrated part may be implemented in form of hardware or software functional part(s).

When implemented in form of a software functional part and sold or used as an independent product, an integrated unit herein may be stored in a computer-readable storage medium. Based on such an understanding, the essential part of the technical solution of the embodiments or a part contributing to prior art or all or part of the technical solution may appear in form of a software product, which software product is stored in storage media, and includes a number of instructions for allowing computer equipment (such as a personal computer, a server, network equipment, and/or the like) or a processor to execute all or part of the steps of the methods of embodiments of the present disclosure. The storage media include various media that can store program codes, such as a U disk, a mobile hard disk, Read-Only Memory (ROM), Random Access Memory (RAM), a magnetic disk, a CD, and/or the like.

Correspondingly, embodiments of the present disclosure provide a computer-readable storage medium having stored thereon program instructions which, when executed by a processor, implement a foregoing training method for training a three-dimensional target detection model, or implement a foregoing three-dimensional target detecting method.

Correspondingly, embodiments of the present disclosure also provide a computer program, including computer-readable code which, when run in an electronic equipment, allows a processor in the electronic equipment to implement a foregoing training method for training a three-dimensional target detection model according to embodiments of the present disclosure, or implement a foregoing three-dimensional target detecting method.

### INDUSTRIAL APPLICABILITY

In the embodiments, an electronic equipment performs target detection with a three-dimensional target detection model, acquiring prediction region information of one or more sub-images of a three-dimensional image, such that electronics implement three-dimensional target detection in one or more sub-images of the three-dimensional image, lowering difficulty in three-dimensional target detection.

1. A training method for training a three-dimensional target detection model, comprising:
acquiring a sample three-dimensional image, wherein the sample three-dimensional image is labeled with actual location information of an actual region of a three-dimensional target;
acquiring one or more pieces of prediction region information corresponding to one or more sub-images of the sample three-dimensional image by performing target detection on the sample three-dimensional image using the three-dimensional target detection model, wherein each piece of the prediction region information comprises prediction confidence and prediction location information of a prediction region;
determining a loss value of the three-dimensional target detection model using the actual location information and the one or more pieces of the prediction region information; and
adjusting a parameter of the three-dimensional target detection model using the loss value.

2. The training method of claim 1, wherein there are a preset number of pieces of the prediction region information, wherein the preset number matches an output size of the three-dimensional target detection model,
wherein determining the loss value of the three-dimensional target detection model using the actual location information and the one or more pieces of the prediction region information comprises:
generating, using the actual location information, the preset number of pieces of actual region information corresponding respectively to the preset number of the one or more sub-images, wherein each piece of the actual region information comprises the actual location information and actual confidence, and actual confidence corresponding to a sub-image where a preset point of the actual region is located is a first value, wherein actual confidence corresponding to the remaining of the one or more sub-images is a second value, wherein the second value is less than the first value;
acquiring a location loss value using the actual location information and the prediction location information of the preset number of the one or more sub-images;
acquiring a confidence loss value using the actual confidence of the preset number of the one or more sub-images and corresponding prediction confidence; and
acquiring the loss value of the three-dimensional target detection model based on the location loss value and the confidence loss value.

3. The training method of claim 2, wherein the actual location information comprises an actual region size and an actual preset point location of the actual region, and the prediction location information comprises a prediction region size and a prediction preset point location of the prediction region,
wherein acquiring the location loss value using the actual location information and the prediction location information of the preset number of the one or more sub-images comprises:
acquiring a first location loss value by performing computation on the actual preset point location of the preset number of the one or more sub-images and a corresponding prediction preset point location using a Binary Cross Entropy function; and
acquiring a second location loss value by performing computation on the actual region size of the preset number of the one or more sub-images and a corresponding prediction region size using a Mean Square Error (MSE) function,
wherein acquiring the confidence loss value using the actual confidence of the preset number of the one or more sub-images and the corresponding prediction confidence comprises:
acquiring the confidence loss value by performing computation on the actual confidence of the preset number of the one or more sub-images and the corresponding prediction confidence using the Binary Cross Entropy function,
wherein acquiring the loss value of the three-dimensional target detection model based on the location loss value and the confidence loss value comprises:
acquiring the loss value of the three-dimensional target detection model by weighting the first location loss value, the second location loss value, and the confidence loss value.

4. The training method of claim 1, further comprising: before determining the loss value of the three-dimensional target detection model using the actual location information and the one or more pieces of the prediction region information,
constraining a value of the actual location information, one or more pieces of the prediction location information, and the prediction confidence to a preset numerical range,
wherein determining the loss value of the three-dimensional target detection model using the actual location information and the one or more pieces of the prediction region information comprises:
determining the loss value of the three-dimensional target detection model using the one or more pieces of the prediction region information and the actual location information as constrained.

5. The training method of claim 4, wherein the actual location information comprises an actual region size and an actual preset point location of the actual region, and the prediction location information comprises a prediction region size and a prediction preset point location of the prediction region,
wherein constraining the value of the actual location information to the preset numerical range comprises:
acquiring a first ratio of the actual region size to a preset size, and taking a logarithm of the first ratio as a constrained actual region size; and
acquiring a second ratio of the actual preset point location to an image size of the one or more sub-images, and taking a decimal part of the second ratio as the actual preset point location constrained,
wherein constraining the one or more pieces of the prediction location information and the prediction confidence to the preset numerical range comprises:
mapping one or more of the prediction preset point location and the prediction confidence respectively to the preset numerical range using a preset mapping function.

6. The training method of claim 5, wherein acquiring the second ratio of the actual preset point location to the image size of the one or more sub-images comprises:
computing a third ratio of an image size of the sample three-dimensional image to a number of the one or more sub-images, and acquiring the second ratio as a ratio of the actual preset point location to the third ratio.

7. The training method of claim 5, wherein the preset numerical range is a range from 0 to 1; and/or, the preset size is an average of region sizes of actual regions of multiple sample three-dimensional images.

8. The training method of claim 1, further comprising at least one of pretreatment steps as follows: before acquiring the one or more pieces of the prediction region information by performing target detection on the sample three-dimensional image using the three-dimensional target detection model,
converting the sample three-dimensional image into a Red, Green, Blue (RGB) color channel image;
scaling the sample three-dimensional image to a set image size; or
performing normalization and standardization processing on the sample three-dimensional image.

9. A three-dimensional target detecting method, comprising:
acquiring a three-dimensional image for detection; and
acquiring target region information corresponding to a three-dimensional target in the three-dimensional image for detection by performing target detection on the three-dimensional image for detection using a three-dimensional target detection model,
wherein the three-dimensional target detection model is acquired through the training method of claim 1.

10. An electronic equipment, comprising a memory and a processor coupled to each other,
the processor being configured to execute program instructions stored in the memory to implement:
acquiring a sample three-dimensional image, wherein the sample three-dimensional image is labeled with actual location information of an actual region of a three-dimensional target;
acquiring one or more pieces of prediction region information corresponding to one or more sub-images of the sample three-dimensional image by performing target detection on the sample three-dimensional image using a three-dimensional target detection model,
wherein each piece of the prediction region information comprises prediction confidence and prediction location information of a prediction region;
determining a loss value of the three-dimensional target detection model using the actual location information and the one or more pieces of the prediction region information; and
adjusting a parameter of the three-dimensional target detection model using the loss value.

11. The electronic equipment of claim 10, wherein there are a preset number of pieces of the prediction region information, wherein the preset number matches an output size of the three-dimensional target detection model,
wherein the processor is configured to determine the loss value of the three-dimensional target detection model using the actual location information and the one or more pieces of the prediction region information, by:
generating, using the actual location information, the preset number of pieces of actual region information corresponding respectively to the preset number of the one or more sub-images, wherein each piece of the actual region information comprises the actual location information and actual confidence, and actual confidence corresponding to a sub-image where a preset point of the actual region is located is a first value, wherein actual confidence corresponding to the remaining of the one or more sub-images is a second value, wherein the second value is less than the first value;
acquiring a location loss value using the actual location information and the prediction location information of the preset number of the one or more sub-images;
acquiring a confidence loss value using the actual confidence of the preset number of the one or more sub-images and corresponding prediction confidence; and
acquiring the loss value of the three-dimensional target detection model based on the location loss value and the confidence loss value.

12. The electronic equipment of claim 11, wherein the actual location information comprises an actual region size and an actual preset point location of the actual region, and the prediction location information comprises a prediction region size and a prediction preset point location of the prediction region,
wherein the processor is configured to acquire the location loss value using the actual location information and the prediction location information of the preset number of the one or more sub-images by:
acquiring a first location loss value by performing computation on the actual preset point location of the preset number of the one or more sub-images and a corresponding prediction preset point location using a Binary Cross Entropy function; and
acquiring a second location loss value by performing computation on the actual region size of the preset number of the one or more sub-images and a corresponding prediction region size using a Mean Square Error (MSE) function,
wherein the processor is configured to acquire the confidence loss value using the actual confidence of the preset number of the one or more sub-images and the corresponding prediction confidence by:
acquiring the confidence loss value by performing computation on the actual confidence of the preset number of the one or more sub-images and the corresponding prediction confidence using the Binary Cross Entropy function,
wherein the processor is configured to acquire the loss value of the three-dimensional target detection model based on the location loss value and the confidence loss value by:
acquiring the loss value of the three-dimensional target detection model by weighting the first location loss value, the second location loss value, and the confidence loss value.

13. The electronic equipment of claim 10, wherein the processor is further configured to implement: before determining the loss value of the three-dimensional target detection model using the actual location information and the one or more pieces of the prediction region information,
constraining a value of the actual location information, one or more pieces of the prediction location information, and the prediction confidence to a preset numerical range,
wherein the processor is configured to determine the loss value of the three-dimensional target detection model using the actual location information and the one or more pieces of the prediction region information by:
determining the loss value of the three-dimensional target detection model using the one or more pieces of the prediction region information and the actual location information as constrained.

14. The electronic equipment of claim 13, wherein the actual location information comprises an actual region size and an actual preset point location of the actual region, and the prediction location information comprises a prediction region size and a prediction preset point location of the prediction region,
wherein the processor is configured to constrain the value of the actual location information to the preset numerical range by:
acquiring a first ratio of the actual region size to a preset size, and taking a logarithm of the first ratio as a constrained actual region size; and
acquiring a second ratio of the actual preset point location to an image size of the one or more sub-images, and taking a decimal part of the second ratio as the actual preset point location constrained,
wherein the processor is configured to constrain the one or more pieces of the prediction location information and the prediction confidence to the preset numerical range by:
mapping one or more of the prediction preset point location and the prediction confidence respectively to the preset numerical range using a preset mapping function.

15. The electronic equipment of claim 14, wherein the processor is configured to acquire the second ratio of the actual preset point location to the image size of the one or more sub-images by:
computing a third ratio of an image size of the sample three-dimensional image to a number of the one or more sub-images, and acquiring the second ratio as a ratio of the actual preset point location to the third ratio.

16. The electronic equipment of claim 14, wherein the preset numerical range is a range from 0 to 1; and/or, the preset size is an average of region sizes of actual regions of multiple sample three-dimensional images.

17. The electronic equipment of claim 10, wherein before acquiring the one or more pieces of the prediction region information by performing target detection on the sample three-dimensional image using the three-dimensional target detection model, the processor is further configured to implement at least one of pretreatment steps as follows:
converting the sample three-dimensional image into a Red, Green, Blue (RGB) color channel image;
scaling the sample three-dimensional image to a set image size; or
performing normalization and standardization processing on the sample three-dimensional image.

18. A three-dimensional target detecting device, comprising a memory and a processor coupled to each other,
the processor being configured to execute program instructions stored in the memory to implement:
acquiring a three-dimensional image for detection; and
acquiring target region information corresponding to a three-dimensional target in the three-dimensional image for detection by performing target detection on the three-dimensional image for detection using a three-dimensional target detection model,
wherein the three-dimensional target detection model is acquired through the electronic equipment of claim 10.

19. A non-transitory computer-readable storage medium, having stored thereon program instructions which, when executed by a processor, implement:
acquiring a sample three-dimensional image, wherein the sample three-dimensional image is labeled with actual location information of an actual region of a three-dimensional target;
acquiring one or more pieces of prediction region information corresponding to one or more sub-images of the sample three-dimensional image by performing target detection on the sample three-dimensional image using the three-dimensional target detection model, wherein each piece of the prediction region information comprises prediction confidence and prediction location information of a prediction region;
determining a loss value of the three-dimensional target detection model using the actual location information and the one or more pieces of the prediction region information; and
adjusting a parameter of the three-dimensional target detection model using the loss value.
